(19) United States
(12) Patent Application Publication
(10) Pub. No.: US 2014/0037413 A1
(43) Pub. Date: Feb. 6, 2014

(54) Suction Chuck and Workpiece Transfer Apparatus Including the Same

(71) Applicants: Hiroki Takashima, Kyoto-shi (JP); Hideaki Nakanishi, Kyoto-shi (JP)

(72) Inventors: Hiroki Takashima, Kyoto-shi (JP); Hideaki Nakanishi, Kyoto-shi (JP)

(73) Assignee: MURATA MACHINERY, LTD., Kyoto-shi, Kyoto (JP)

(21) Appl. No.: 14/112,222

(22) PCT Filed: Feb. 23, 2012
(86) PCT No.: PCT/JP2012/001221

§ 371 Date: Oct. 16, 2013

(30) Foreign Application Priority Data
Apr. 20, 2011 (JP) 2011-094215

(51) Int. Cl. B25J 15/06

(52) U.S. Cl. CPC B25J 15/0616
USPC 414/680; 279/3; 294/183

(57) ABSTRACT

Provided is a suction chuck that is lightweight and that sucks and releases a thin plate workpiece in such a manner that the thin plate workpiece is not in contact with an edge of the chuck. A suction chuck according to an embodiment of the present invention includes a main body having a flat plate shape, and an opposing surface. Compressed air passages are formed within the main body. The opposing surface is a surface of the main body at the side facing the workpiece. The opposing surface has a plurality of recesses formed therein. The plurality of recesses serve as a sucking element for generating a negative pressure by ejecting the compressed air. The opposing surface is formed with a shape similar to the shape of the workpiece (or with a shape that corresponds to the shape of the workpiece being offset outward) such that the shape of the opposing surface is able to completely cover the shape of the workpiece when seen along a direction perpendicular to the opposing surface. The recesses are arranged such that all of the recesses are coverable by the shape of the workpiece when seen along the direction perpendicular to the opposing surface.

### TECHNICAL FIELD

The present invention relates mainly to a suction chuck for sucking a workpiece of thin flat-plate shape and holding the workpiece in a non-contact state.

### BACKGROUND ART

For transfer of a workpiece (thin plate workpiece) in the shape of a thin flat plate such as a solar cell wafer, a fuel battery cell, or an electrode or a separator of a secondary battery, a transfer apparatus that adopts a Bernoulli chuck using the Bernoulli effect as an end effector has been conventionally proposed (for example, see Patent Document 1).

The present applicant proposes, as a transfer mechanism of the transfer apparatus, a parallel mechanism robot disclosed in Patent Document 2, and also proposes, as a suction chuck, a Bernoulli chuck disclosed in Patent Document 3.

In the Bernoulli chuck, because of its structure, occurrence of vertical vibrations of a thin plate workpiece being sucked is inevitable. In a case where the Bernoulli chuck has a size smaller than a workpiece, the thin plate workpiece may vibrate and contact an outer periphery (edge) of the Bernoulli chuck at a time of a sucking operation on the thin plate workpiece or at a time of releasing thereof, which may damage the workpiece or deteriorate the performance of the workpiece.

Particularly, the above-mentioned parallel mechanism is configured to move an end effector at a high speed by means of three arms. To make use of the characteristics thereof, it is necessary that a Bernoulli chuck adopted as an end effector is lightweight. As a structure of the Bernoulli chuck for achieving such Iightweighting, many structures including the ones disclosed in Patent Documents 4 to 6 have been proposed.

### PRIOR-ART DOCUMENTS

### Patent Documents

Patent Document 1: Japanese Patent No. 3981241

Patent Document 2: Republication of PCT International Publication No. 2008-59659

Patent Document 3: Japanese Patent No. 4538849

Patent Document 4: Japanese Patent Application Laid-Open No. 2007-324442

Patent Document 5: Japanese Patent Application Laid-Open No. 2008-119758

Patent Document 6: Japanese Patent Application Laid-Open No. 2005-74606

### SUMMARY OF THE INVENTION

### Problems to be Solved by the Invention

The present invention has been made in view of the circumstances described above, and a primary object of the present invention is to provide a suction chuck that is lightweight and that sucks and releases a thin plate workpiece in such a manner that the thin plate workpiece is not in contact with an edge of the chuck.

### Means for Solving the Problems and Effects Thereof

Problems to be solved by the present invention are as described above, and next, means for solving the problems and effects thereof will be described.

In a first aspect of the present invention, a suction chuck having the following configuration is provided. The suction chuck is configured to suck a workpiece of thin flat-plate shape and hold the workpiece in a non-contact state. The suction chuck includes a main body having a flat plate shape, and an opposing surface. In the main body, passages for a compressed gas are formed. The opposing surface is a surface of the main body at the side facing the workpiece. The opposing surface has a plurality of recesses formed therein. The plurality of recesses serve as a sucking element for generating a negative pressure by ejecting the compressed gas. The opposing surface is formed with a shape similar to the shape of the workpiece or with a shape that corresponds to the shape of the workpiece being offset outward, such that the shape of the opposing surface is able to completely cover the shape of the workpiece when seen along a direction perpendicular to the opposing surface. The recesses are arranged such that all of the recesses are coverable by the shape of the workpiece when seen along the direction perpendicular to the opposing surface.

This can well prevent the workpiece from being broken by a contact with an outer periphery of the opposing surface or an edge of the recess, and also enables sucking through the recesses to act efficiently, so that the workpiece is held stably. Additionally, since sucking is performed by means of the recesses formed in the opposing surface, it is easy to make the suction chuck lightweight and compact.

In the suction chuck, it is preferable that the opposing surface and the workpiece have right-angled quadrangular shapes when seen along the direction perpendicular to the opposing surface.

Accordingly, the workpiece having a right-angled quadrangular shape, which is a widely adopted shape, can be smoothly held without being broken.

Preferably, the suction chuck is configured as follows. The opposing surface has escape holes formed therein. The escape holes are opened around the recesses and configured to discharge the compressed gas ejected from the recesses. The escape holes are arranged such that all of the escape holes are coverable by the shape of the workpiece when seen along the direction perpendicular to the opposing surface.

This allows the sucking through the recesses to be efficiently exerted. Additionally, a lower flow rate can be used to achieve the same level of suction force. This is suitable for use in a clean room environment which requires suppression of the flow rate. Furthermore, break of the workpiece caused by a contact thereof with an edge of the escape hole can be prevented well.

In the suction chuck, it is preferable that the plurality of recesses are orderly arranged such that a line of the recesses is in parallel with a side of the shape of the opposing surface when seen along the direction perpendicular to the opposing surface.

This allows the sucking through the recesses to act on the workpiece without non-uniformity. Therefore, the workpiece can be held stably.

Preferably, the suction chuck is configured as follows. The recess has a cylindrical shape. The main body includes an ejection passage configured to eject the compressed gas in a direction along an inner wall of the recess.

Accordingly, with a simple configuration, a good swirling flow can be generated within the recess.

In the suction chuck, it is preferable that the ejection passage is formed so as to extend in parallel with the opposing surface.

Accordingly, a passage structure can be simplified and made compact.

In the suction chuck, it is preferable that a plurality of the ejection passages are formed for one recess.

Accordingly, a stable swirling flow with a strong force can be generated in the recess.

Preferably, the suction chuck is configured as follows. The main body is formed of a plurality of plates being bonded in a thickness direction. The plurality of plates include a first plate and a second plate. The first plate has the opposing surface. The second plate is connected to a compressed gas source that is a source for supplying the compressed gas. The first plate has an open hole. The open hole is opened in the opposing surface. The open hole constitutes at least a part of the recess. The ejection passage is arranged at a position between the opposing surface and the second plate. The second plate has a connection port and a supply groove. The connection port is connected to the compressed gas source and arranged at the side opposite to the side close to the first plate. The supply groove is formed in a surface of the second plate at the side close to the first plate. The supply groove constitute a supply passage through which the compressed gas introduced to the connection port is led to the ejection passage.

Accordingly, a passage structure with a simple configuration is achieved.

Preferably, the suction chuck is configured as follows. An intermediate plate is arranged between the first plate and the second plate. The intermediate plate has a slit formed therethrough in a thickness direction. The slit constitutes the ejection passage.

Accordingly, the ejection passage can be formed with a simple configuration.

Preferably, the suction chuck is configured as follows. A third plate is arranged between the first plate and the second plate. The third plate has a connection hole formed therein. The connection hole connects the ejection passage and the supply groove to each other. A surface of the third plate at one side with respect to a thickness direction constitutes a part of the inner wall of the ejection passage. A surface of the third plate at the other side with respect to the thickness direction closes an open side of the supply groove, so that the supply passage is formed.

Accordingly, a passage for the compressed gas can be formed with a simple configuration.

Preferably, the suction chuck includes at least one said supply passage. Each of said supply passages is connected to a plurality of the ejection passages.

Accordingly, the compressed gas can be supplied from the supply passage to the plurality of ejection passages. Therefore, the passage from the compressed gas source to the connection port can be simplified.

Preferably, the suction chuck is configured as follows. The suction chuck includes a plurality of the supply passages. A combination of the connection port and the ejection passages connected by one of the supply passages is independent of a combination of the connection port and the ejection passages connected by another of the supply passages.

Accordingly, which recess causes the sucking can be easily controlled by changing the connection port to which the compressed gas is supplied.

In the suction chuck, it is preferable that each of the plurality of plates is made of a metal, and the main body is formed by laminating all the plurality of plates and diffusion-bonding the plurality of plates in a laminated state to one another.

Accordingly, the main body in which a passage for the compressed gas is provided can be formed through a simple process.

In the suction chuck, it is preferable that the plurality of plates are made of a material selected from the group consisting of stainless steel, an aluminum alloy, and a titanium alloy.

Accordingly, a low-cost suction chuck can be provided.

In the suction chuck, it is preferable that the plurality of plates are made of the same metal material.

Accordingly, a suction chuck causing less distortion and achieving a good accuracy of dimension can be provided.

In the suction chuck, it may be acceptable that at least either of the recess and the ejection passage is formed through an etching process.

In this case, the passage structure can be made easily.

In the suction chuck, it may be also acceptable that at least either of the recess and the ejection passage is formed through a machining process.

In this case, the degree of freedom in the shape of the passage structure can be improved.

In the suction chuck, it is preferable that at least either of the connection port and the supply groove is formed through a machining process.

Accordingly, the degree of freedom in the shape of the passage structure can be improved.

In a second aspect of the present invention, a workpiece transfer apparatus having the following configuration is provided. The transfer apparatus includes the suction chuck described above, and a compressed gas source. The compressed gas source is a source for supplying the compressed gas to the suction chuck. The amount of the compressed gas ejected from the recess that is located in a central portion of the opposing surface is larger than the amount of the compressed gas ejected from the recess that is located in an end portion of the opposing surface.

Accordingly, the workpiece can be held while maintaining a more flat shape.

In a third aspect of the present invention, a workpiece transfer apparatus having the following configuration is provided. The transfer apparatus includes the suction chuck described above, and a compressed gas source. The compressed gas source is a source for supplying the compressed gas to the suction chuck. The transfer apparatus is configured to separate uppermost one workpiece away from a batch of workpieces that is a stack of a plurality of the workpieces, and to hold the uppermost one workpiece by the suction chuck. The transfer apparatus is configured to hold the workpiece positioned in an uppermost layer of the batch of workpieces, by supplying the compressed gas to, among the plurality of recesses arranged in the suction chuck, the recesses located in an end portion of the opposing surface and then supplying the compressed gas to the recesses located in a central portion of the opposing surface.

Accordingly, sucking of the workpiece can be performed in such a manner that the workpiece is curled upward from an end portion thereof. Therefore, a smooth transfer operation is achieved.

Preferably, the workpiece transfer apparatus includes a sprayer configured to blast compressed gas toward a side surface of the batch of workpieces.

This makes it easy to separate the workpiece away from the batch of workpieces. Therefore, a smooth transfer operation is achieved.

Preferably, the workpiece transfer apparatus includes a parallel mechanism configured to move a workpiece being held by the suction chuck.

Accordingly, the effects exerted by the configuration of the suction chuck described above can be applied to a transfer robot of parallel mechanism type.

Preferably, the workpiece transfer apparatus includes a scara arm configured to move a workpiece being held by the suction chuck.

Accordingly, the effects exerted by the configuration of the suction chuck described above can be applied to the transfer robot of scara arm type.

### BRIEF DESCRIPTION OF THE DRAWINGS

FIG. 1 A perspective view showing a transfer robot serving as a transfer apparatus according to an embodiment of the present invention.

FIG. 2 A perspective view showing a workpiece feeder included in the transfer robot.

FIG. 3 A perspective view of a suction chuck as seen from the upper side thereof.

FIG. 4 An exploded perspective view showing four plates included in the suction chuck, as seen from the lower side thereof.

FIG. 5 A schematic cross-sectional view showing a compressed air passage that is formed within a main body of the suction chuck.

FIG. 6 A perspective view showing, on an enlarged scale, the compressed air passage that is formed within the main body of the suction chuck.

FIG. 7 (a) is a bottom view of the suction chuck, and (b) is a side view of the suction chuck.

FIG. 8 A bottom view showing, on an enlarged scale, directions of swirling flows ejected from recesses of the suction chuck.

FIG. 9 A reference side view showing a situation where, to hold a workpiece by the suction chuck, sucking is simultaneously started in all the recesses.

FIG. 10 A side view showing a situation where, to hold a workpiece by the suction chuck, sucking is sequentially started from the recess located in an end portion of the workpiece.

FIG. 11 A bottom view showing an example in which sucking is started from the recess located in the end portion of the workpiece.

FIG. 12 A side view showing a situation where air is blasted to a side surface of a batch of workpieces.

FIG. 13 Graphs showing the relationship between a flow rate and a suction force in the suction chuck of this embodiment and in a suction chuck of a reference example.

FIG. 14 Graphs each showing a result of measurement of deformation of a workpiece in a state where the workpiece is held by the suction chuck.

FIG. 15 Graphs each showing a result of measurement of an acceleration of vibration of a workpiece in a state where the workpiece is held by the suction chuck.

FIG. 16 A plan view showing a modification in which the suction chuck is applied to a transfer robot having a scara arm.

### EMBODIMENT FOR CARRYING OUT THE INVENTION

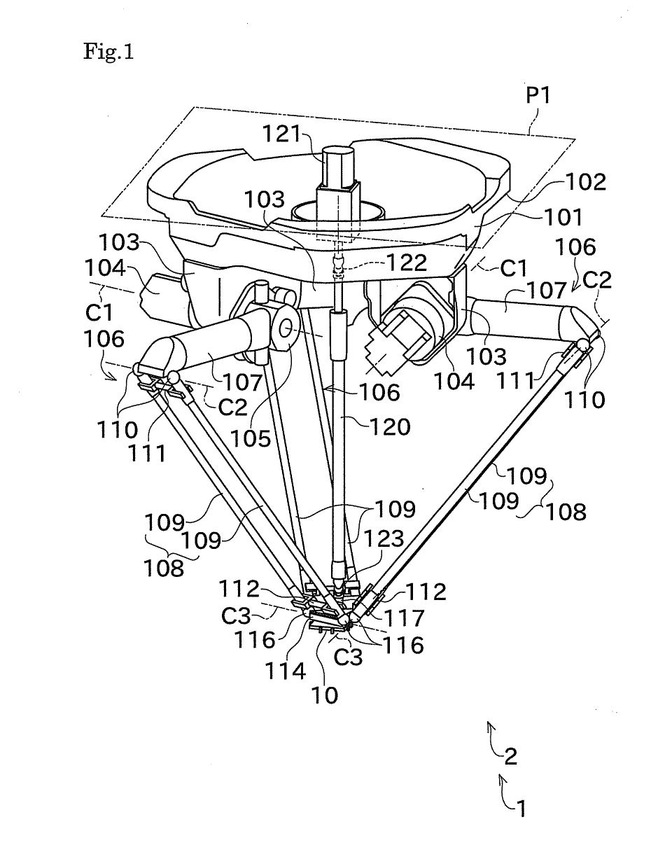

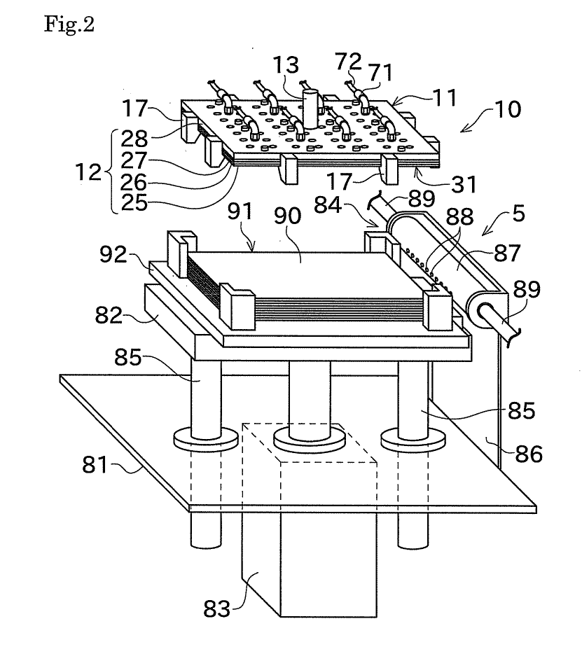

Next, an embodiment of the present invention will be described with reference to the drawings. FIG. 1 is a perspective view showing a transfer robot 1 serving as a transfer apparatus according to an embodiment of the present invention. FIG. 2 is a perspective view showing a workpiece feeder 5 included in the transfer robot 1.

As shown in FIG. 1, the transfer robot (transfer apparatus) 1 of this embodiment includes a parallel mechanism 2 having a suction chuck (Bernoulli chuck) 10 mounted thereto. The parallel mechanism 2 mainly includes a base member 101, support members 103, electric motors 104, arm support members 105, arm main bodies 106, and an end plate 114. As shown in FIG. 2, the transfer robot 1 includes the workpiece feeder 5 that is configured to feed a workpiece 90 having a flat plate shape, which is an object of transfer, to the parallel mechanism 2. FIG. 2 shows the suction chuck 10 in a state of being removed from the parallel mechanism 2, for facilitating the understanding of the positional relationship among members.

A workpiece formed in the shape of a thin flat plate is assumed as the workpiece 90 handled by the transfer robot 1 of this embodiment. Non-limiting examples of the workpiece 90 include a solar cell wafer, a fuel battery cell, and an electrode, a separator, or a silicon wafer of a secondary battery.

The parallel mechanism 2 shown in FIG. 1 is configured to move the end plate 114 arranged below the base member 101 within a predetermined operation area that is defined based on the base member 101. The end plate 114 serves as an output member. The suction chuck 10 is an apparatus configured to suck the workpiece 90 and hold the workpiece 90 in a non-contact state by feeding compressed air (compressed gas). The suction chuck 10 is rotatably attached to the end plate 114.

The base member 101 is a member for supporting the parallel mechanism 2, and, in a plan view, arranged substantially at the center of a range of movement of the end plate 114. The base member 101 has an attaching surface 102 that is horizontal.

A frame (not shown) included in the transfer robot 1 has an attached surface P1 that is horizontal. In this configuration, the base member 101 is fixed to the attached surface P1 via the attaching surface 102, and thereby the parallel mechanism 2 can be placed in a suspended manner.

Three support members 103 are fixed to the lower surface side of the base member 101. The three support members 103 are attached side by side at equal intervals in a circumferential direction around a central portion of the base member 101 in a plan view. Each of the support members 103 supports the electric motor 104 having a speed reducer. Each of the electric motors 104 is arranged such that an axis line C1 of its output shaft (that is, an output shaft of its speed reducer) is horizontal. The three electric motors 104 of the parallel mechanism 2 are arranged such that the axis lines C1 of the three electric motors 104 form a regular triangle with the center thereof located at the central portion of the base member 101 in a plan view.

The arm support member 105 is fixed to the output shaft of each electric motor 104. The arm support member 105 is arranged such that its axis line is coincident with the output shaft of the electric motor 104. When the electric motor 104 is driven, the arm support member 105 rotates around the axis line C1.

The arm main body 106 that is bendable is fixed to each arm support member 105. The arm main body 106 includes a first arm 107 and a second arm 108.

The first arm 107 is an elongated member, and one longitudinal end thereof is fixed to the arm support member 105. The first arm 107 is arranged such that its longitudinal direction is perpendicular to the axis line of the arm support member 105 (to the axis line C1 of the electric motor 104), and the first arm 107 extends outwardly from a connecting portion with the arm support member 105 in a plan view.

The second arm 108 includes a pair of elongated rods 109 arranged in parallel. One end of the second arm 108 (that is, one end of each rod 109) is supported on an end portion of the first arm 107.

The pair of rods 109 included in the second arm 108 are coupled to each other via the first arm 107 and ball joints 110. Therefore, the rods 109 are able to rotate in any direction. A line connecting the pair of ball joints 110 (the axis line C2 that serves as a reference based on which the arm main body 106 is bent and stretched) is in parallel with the axis line C1 of the electric motor 104.

As the first arm 107 and the second arm 108, for example, hollow arms having cylindrical shapes and made of a carbon fiber reinforced plastic may be adopted.

At one end of the second arm 108, the pair of rods 109 are coupled by a coupling member 111, and at the other end of the second arm 108, too, the pair of rods 109 are coupled by a coupling member 112. The coupling members 111 and 112, each including a bias member such as a spring (not shown), bias the pair of rods 109 to each other. The coupling members 111 and 112 prevent the rods 109 from rotating around the center axes thereof.

The end plate 114 is a flat-plate-like member in the shape of a substantially regular triangle in a plan view. The suction chuck 10 is rotatably attachable to the end plate 114. The end plate 114 is attached to a distal end of each of the three arm main bodies 106. The end plate 114 is held in such a posture that a lower surface of the end plate 114 is horizontal.

The end plate 114 having a triangular shape has the three sides thereof coupled to end portions of the respective three second arms 108 (three pairs of rods 109) via ball joints 116. Since the pair of rods 109 included in the second arm 108 have equal lengths, an axis line C3 connecting one pair of ball joints 116 is always in parallel with the axis line C2 of the corresponding arm main body 106. Accordingly, the axis line C3 at the distal side of the arm main body 106 is in parallel with the axis line C1 of the electric motor 104, too.

This means that the three side of the end plate 114 having a triangular shape are always in parallel with the axis lines C1 of the corresponding electric motors 104. Therefore, no matter how each of the three first arms 107 rotates around the axis line C1, the end plate 114 is able to always maintain the posture in which its lower surface (the surface to which the suction chuck 10 is attached) is horizontal.

An electric motor 121 with a speed reducer is fixed to the central portion of the base member 101 in a plan view. An output shaft of the electric motor 121 (that is, an output shaft of the speed reducer) is directed vertically downward. A lower end of the output shaft is coupled via a universal joint 122 to an upper end of a pivot shaft rod 120 that is arranged in the vertical direction.

A pivotal output shaft 117 is rotatably supported on a central portion of the end plate 114. A rotation axis line of the pivotal output shaft 117 is perpendicular to the end plate 114. A lower end of the pivot shaft rod 120 is coupled via a universal joint 123 to the pivotal output shaft 117.

The pivot shaft rod 120 includes a spline mechanism (not shown). The pivot shaft rod 120 is extendable and retractable in accordance with movement of the end plate 114, and configured to transmit rotation of the electric motor 121 to the pivotal output shaft 117. Therefore, driving the electric motor 121 can cause the suction chuck 10 to rotate relative to the end plate 114.

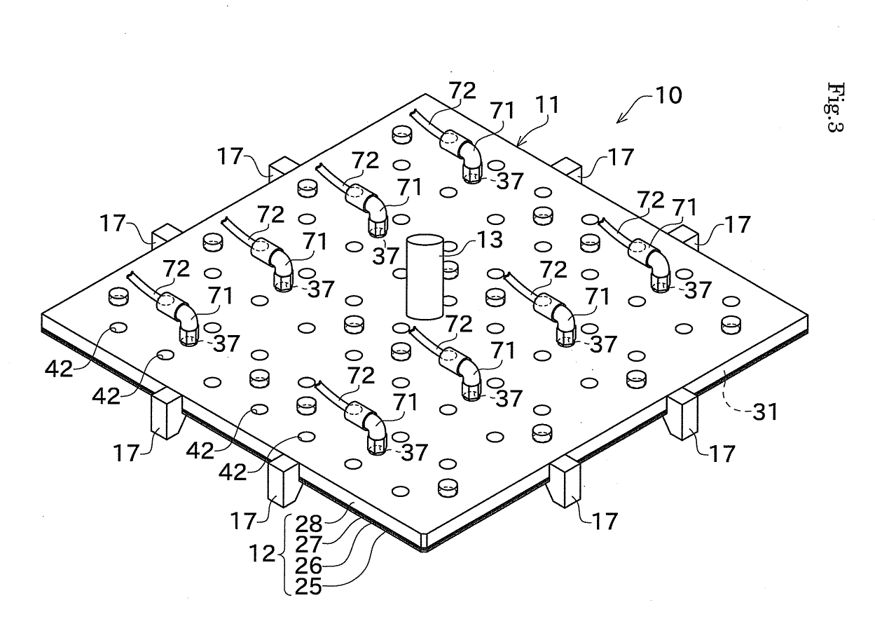

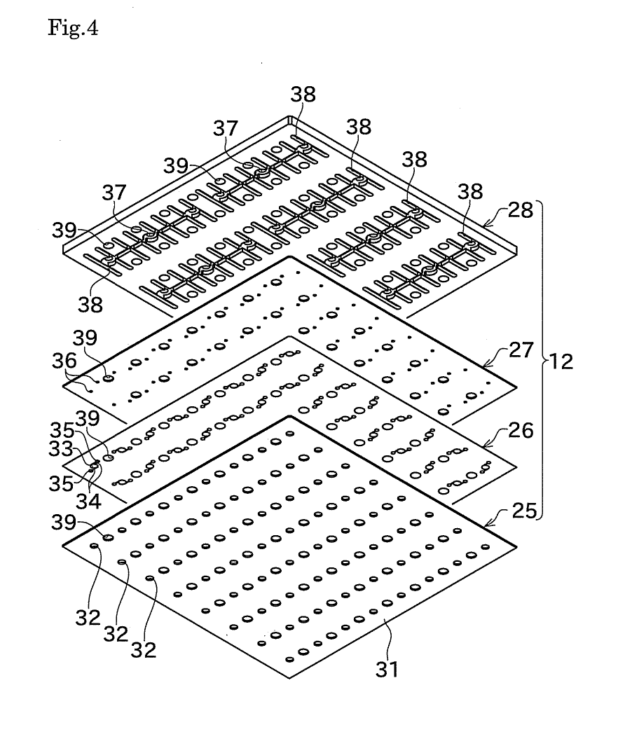

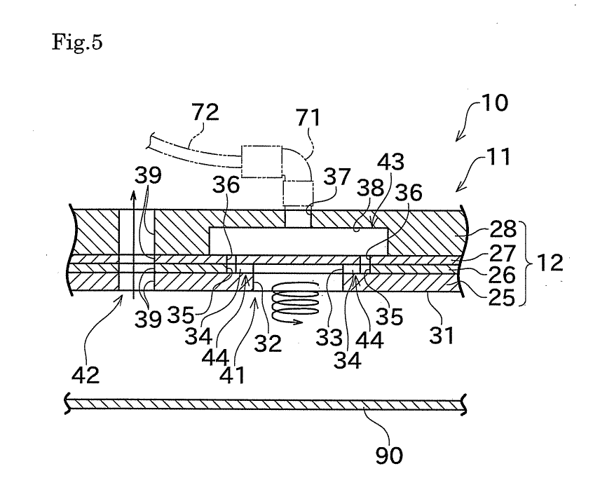

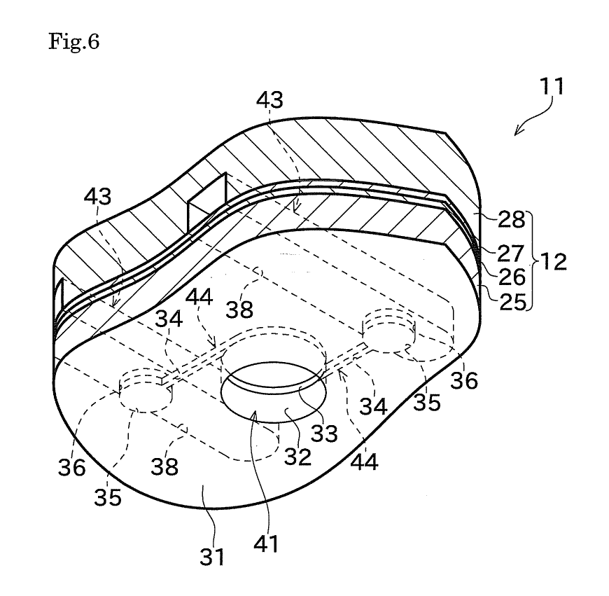

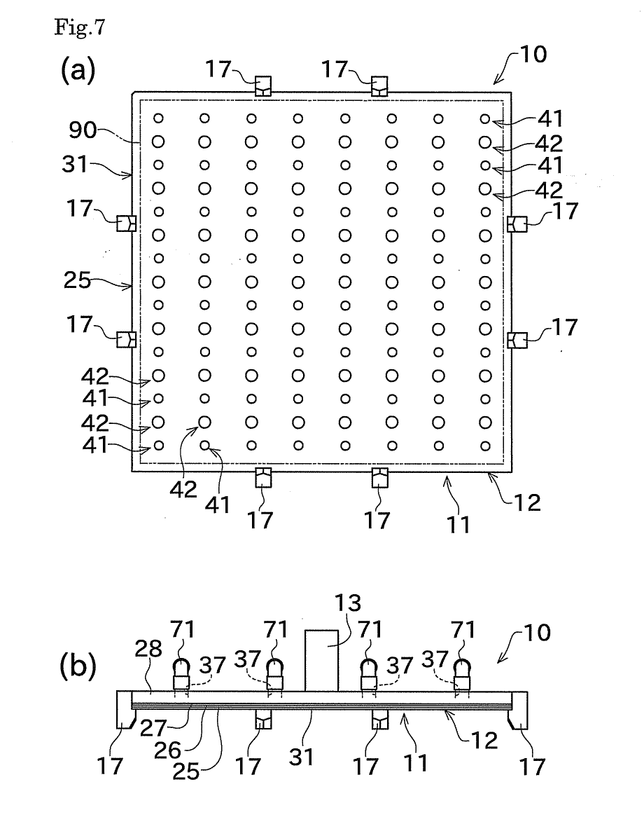

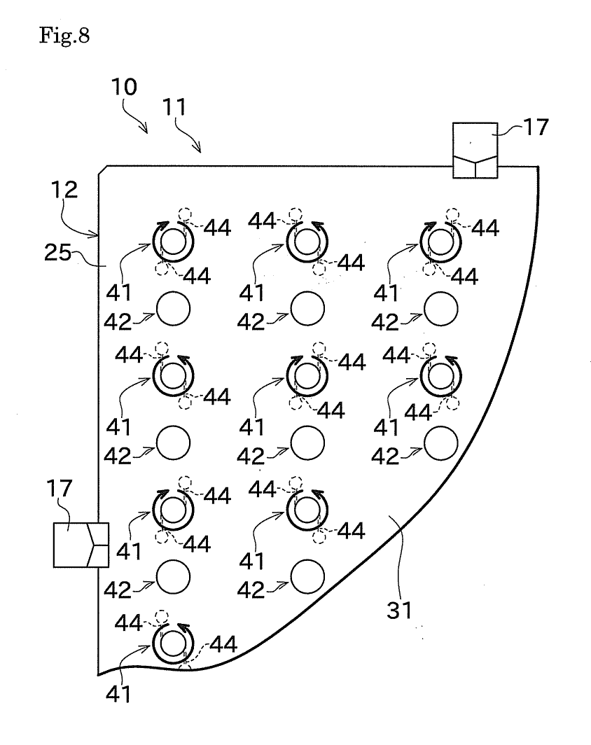

Next, a detailed configuration of the suction chuck 10 will be described. FIG. 3 is a perspective view of the suction chuck 10 as seen from the upper side thereof. FIG. 4 is an exploded perspective view showing four plates 25 to 28 included in the suction chuck 10, as seen from the lower side thereof. FIG. 5 is a schematic cross-sectional view showing a compressed air passage that is formed within a main body 11 of the suction chuck 10. FIG. 6 is a perspective view showing, on an enlarged scale, the compressed air passage that is formed within the main body 11 of the suction chuck 10. FIG. 7(a) is a bottom view of the suction chuck 10. FIG. 7(b) is a side view of the suction chuck 10. FIG. 8 is a bottom view showing, on an enlarged scale, directions of swirling flows ejected from recesses 41 of the suction chuck 10.

As shown in FIGS. 2 and 3, the suction chuck 10 includes the main body 11 having a flat plate shape. The main body 11 is constituted of a plate-laminated body 12 that is obtained by a plurality of plates being stacked and bonded. The plate-laminated body 12 includes a surface plate (first plate) 25, a nozzle plate (intermediate plate) 26, a connecting plate (third plate) 27, and a distribution plate (second plate) 28, which are arranged in this order from the side (lower side) close to the workpiece 90.

An attachment shaft 13 is fixed to an upper surface of the main body 11 (plate-laminated body 12). The attachment shaft 13 is coupled to the pivotal output shaft 117, and thereby the suction chuck 10 can be mounted to the parallel mechanism 2.

As shown in FIG. 4, a lower surface of the surface plate 25 has an opposing surface 31 that can be directly opposed to the workpiece 90. The opposing surface 31 is a flat surface having a rectangular shape (right-angled quadrangular shape) that extends perpendicularly to the thickness direction of the main body 11. The surface plate 25 has circular holes (open holes) 32 for ejecting swirling flows. The circular holes (open holes) 32 are formed through the surface plate 25 in the thickness direction.

As shown in FIGS. 4 to 6, the nozzle plate 26 has circular holes 33, slits 34 in the shape of elongated lines, and circular inflow holes 35. The position and the size of the circular hole 33 are coincident with the circular hole 32 of the surface plate 25. The slit 34 is formed tangentially to the circular hole 33. The inflow hole 35 is for supplying compressed air to the slit 34. All of them are formed through the nozzle plate 26 in the thickness direction. As shown in FIG. 6 and the like, two slits 34 and two inflow holes 35 are provided for one circular hole 33. One longitudinal end of the slit 34 is connected to the circular hole 33, and the other longitudinal end thereof is connected to the inflow hole 35.

The connecting plate 27 has small connection holes 36 each having a circular shape and formed through the connecting plate 27 in the thickness direction. The connection hole 36 is arranged at a position corresponding to the inflow hole 35 formed in the nozzle plate 26.

As shown in FIG. 3, the distribution plate 28 has a plurality of circular connection ports 37. The connection ports 37 are open in a surface of the distribution plate 28 facing the side opposite to the surface plate 25 (facing the side opposite to the opposing surface 31). The connection port 37 is connected to an appropriate compressed air source (such as a compressor) via a joint member 71, a pipe 72, and an electromagnetic valve (not shown). As shown in FIG. 4, a plurality of distribution grooves (supply grooves) 38 formed in a surface of the distribution plate 28 at the surface plate 25 side (a surface thereof at the opposing surface 31 side). The compressed air source can be changed as appropriate to another compressed gas source in accordance with, for example, the type of the workpiece 90 conveyed. For example, a liquefied nitrogen tank may be adoptable instead of the compressed air source.

Discharge holes 39 are formed through each of the surface plate 25, the nozzle plate 26, the connecting plate 27, and the distribution plate 28. The positions of the discharge holes 39 in the respective plates correspond to one another.

In the above-described configuration, the four plates 25 to 28 are laminated, so that the circular holes 32 of the surface plate 25 are aligned with the circular holes 33 of the nozzle plate 26 while the connecting plate 27 closes the circular holes 33 of the nozzle plate 26 at one side. As a result, circular recesses 41 opening in the opposing surface 31 are formed (see FIG. 6).

Since an opening portion of each distribution groove 38 is closed by the connecting plate 27, a distribution passage (supp)y passage) 43 connecting the connection hole 36 to the connection port 37 are formed at a position of each distribution groove 38.

Additionally, each slit 34 formed in the nozzle plate 26 is, at one side thereof with respect to the thickness direction, closed by the surface plate 25, and at the other side thereof with respect to the thickness direction, closed by the connecting plate 27. As a result, a nozzle passage (ejection passage) 44 for jetting compressed air into the recess 41 is formed at a position of each slit 34. The nozzle passage 44 is arranged at a position between the surface plate 25 and the distribution plate 28 (between the opposing surface 31 and the distribution plate 28), and arranged in parallel with the opposing surface 31 of the main body 11.

In the above-described configuration, the recess 41 is connected to the connection port 37 formed in the distribution plate 28 via the distribution passage 43 (distribution groove 38), the connection hole 36, the inflow hole 35, and the nozzle passage 44 (slit 34).

The discharge holes 39 formed in the four plates 25 to 28 are aligned, so that an escape hole 42 penetrating the whole of the plate-laminated body 12 in the thickness direction is formed as shown in FIG. 5. The escape hole 42 is used for allowing the air ejected downward from the recess 41 to escape upward.

For the viewpoint of the cost and the like, it is preferable to adopt a metal as a material of the four plates 25 to 28. Specific examples of the material of the plates 25 to 28 include stainless steel, an aluminum alloy, and a titanium alloy. All the four plates 25 to 28 are laminated, and in this state, diffusion-bonded to each other, into the plate-laminated body 12 (main body 11) within which a compressed air passage is formed.

To provide the suction chuck 10 having a less distortion and a good accuracy of dimension, it is preferable that the four plates 25 to 28 are made of the same material. This is because diffusion-bonding different kinds of metals may cause deformation such as deflection due to residual distortion after the bonding. In this embodiment, stainless steel is adopted as the material of all the four plates 25 to 28.

The circular holes 32, the circular holes 33, the slits 34, the inflow holes 35, the connection holes 36, the connection ports 37, the distribution grooves 38, and the discharge holes 39 provided in the four plates 25 to 28 may be formed through an etching process, a machining process such as punching and drilling, or the like. As a passage processing method, an appropriate method suitable for preparation of a desired shape can be selected in consideration of the quality, cost, and the like.

In the main body 11 having the above-described configuration, the opposing surface 31 is brought close to the uppermost workpiece 90 of the batch of workpieces 91, and in this state, compressed air is supplied to the connection ports 37. As a result, the air is jetted through the nozzle passages 44 (slits 34) in a direction along an inner wall of each recess 41 having a cylindrical shape. The jetted air advances while swirling along an inner wall surface of the circular recess 41, and is discharged from an opening end of the recess 41.

An airflow ejected into a space between the opposing surface 31 and the workpiece 90 is discharged to the upper side through the escape hole 42, as shown in FIG. 5. Therefore, at a time when the airflow advancing along the inner wall surface of the recess 41 is discharged to the opposing surface 31, the flow velocity of the airflow increases so that the internal pressure of the recess 41 drops. A negative pressure occurring at this time generates a suction force on the workpiece 90. Due to the suction force and the presence of a layer of the air discharged from the recess 41, the workpiece 90 is held in a non-contact state by the suction chuck 10. Therefore, the recess 41 acts as a sucking element of the suction chuck 10.

As shown in FIG. 7(a), the opposing surface 31 of the main body 11 of the suction chuck 10 has a rectangular (right-angled quadrangular) contour, or even a square contour. The shape of the opposing surface 31 is similar to that shape of the workpiece 90 (indicated by the dot-dash-line in FIG. 7) that is an object of transfer. The opposing surface 31 is slightly larger than the workpiece 90 when seen along a direction perpendicular to the opposing surface 31. As a result, the shape of the opposing surface 31 is able to completely cover the shape of the workpiece 90. In other words, the opposing surface 31 has a shape that is offset outward from the workpiece 90 by a predetermined distance.

This can effectively prevent the workpiece 90 from being damaged. To be specific, in a case where the workpiece 90 is held in a non-contact state by the suction chuck 10 and moved together with the end plate 114, there may be a possibility that a contact of the workpiece 90 with the opposing surface 31 of the suction chuck 10 occurs under some circumstances such as where inertia acts on the workpiece 90. In this embodiment, however, the opposing surface 31 is larger than the workpiece 90. Therefore, even if the workpiece 90 comes into contact with a flat portion of the opposing surface 31, damage to the workpiece 90, which may be caused by a contact with an outer peripheral portion (sharp edge) of the opposing surface 31, can be prevented.

In this embodiment, the recesses 41 are arranged on the opposing surface 31 in a regular manner at equal intervals in the longitudinal and lateral directions (in other words, directions in parallel with the sides of the right-angled quadrangular contour of the opposing surface 31). All of the recesses 41 arranged on the opposing surface 31 are positioned in a region that is coverable by the shape of the workpiece 90 (that is, they are positioned inside the shape of the workpiece 90 which is indicated by the dot-dash-line in FIG. 7(a).

This allows a suction force and a repulsive force exerted by the recesses 41 to act efficiently on the workpiece 90, so that the workpiece 90 can be stably held in a non-contact state. Since sucking is performed by means of the recesses 41 formed in the opposing surface 31, it is easy to make the suction chuck 10 lightweight and compact. Additionally, even if the workpiece 90 comes into contact with the opposing surface 31, occurrence of a contact between a peripheral portion of the workpiece 90 and a peripheral edge of an opening of each recess 41 can be prevented.

The escape hole 42 is arranged between the recess 41 and the recess 41 such that the escape hole 42 is adjacent to the recess 41 with respect to the vertical direction of FIG. 7(a). Since the escape hole 42 is arranged around the recess 41 in this manner, the air ejected from the recess 41 into a space between the suction chuck 10 and the workpiece 90 can be smoothly expelled through the escape hole 42. Thus, a stable suction force is achieved. Moreover, all the escape holes 42 are arranged in a region that is coverable by the shape of the workpiece 90. Accordingly, occurrence of a contact between the peripheral portion of the workpiece 90 and a peripheral edge of an opening of each escape hole 42 can be prevented, similarly to the case of each recess 41.

FIG. 8 shows, on an enlarged scale, a part of the suction chuck 10 as seen from the bottom surface side thereof. As described above, each recess 41 has a circular inner wall, and the nozzle passage 44 (the slit 34) is formed such that it is tangentially connected to the inner wall. Two nozzle passages 44 are formed for one recess 41. The nozzle passages 44 are, in their end portions, opened in the inner wall of the recess 41 with a phase shift of 180° therebetween. Thus, the air is simultaneously ejected from a plurality of nozzle passages 44 to one recess 41. This enables a stable swirling flow to be generated in the recess 41.

In this embodiment, comparing two adjacent recesses 41 opened in the opposing surface 31, the direction in which the nozzle passages 44 are connected to one recess 41 is opposite to the direction in which the nozzle passages 44 are connected to the other recess 41. More specifically, as for the recess 41 arranged at the upper left corner in FIG. 8, the nozzle passages 44 are connected to this recess 41 such that a clockwise swirling flow is generated within the recess 41. As for the recess 41 that is adjacent to and located at the right or lower side of the recess 41 arranged in the upper left corner, the nozzle passages 44 are connected to this recess 41 such that a counterclockwise swirling flow is generated within the recess 41. Thus, in the suction chuck 10 of this embodiment, the recesses 41 in which swirling flows having opposite swirling directions are generated are alternately arranged. In this configuration, these flows are not likely to hinder each other, and non-uniformity in the suction force can be reduced. The swirling flow generates a force that urges the workpiece 90 to rotate in a horizontal plane. Such forces can cancel out each other, because the number of recesses 41 in which the clockwise swirling flows are generated is equal to the number of recesses 41 in which the counterclockwise swirling flows are generated. As a result, unnecessary rotation of the workpiece 90 can be prevented.

The total number of distribution passages 43, each of which is constituted by the distribution groove 38 (FIG. 4), is eight, such that each of the distribution passages 43 corresponds to each of 2×4 regions of the opposing surface 31 being divided. Each distribution passage 43 connects one connection port 37 to connection holes 36 (sixteen connection holes 36 in total) that are connected to eight recesses 41 opened in the corresponding region.

In this embodiment, to hold the workpiece 90, the compressed air is not simultaneously supplied to all the connection ports 37. Instead, the compressed air is firstly supplied to the connection ports 37 located at one end side in the opposing surface 31, and then the compressed air is supplied to the connection ports 37 located at the center side. Such a time lag in sucking is achieved through an appropriate control on a timing at which the compressed air is supplied to each connection port 37 with use of the electromagnetic valve.

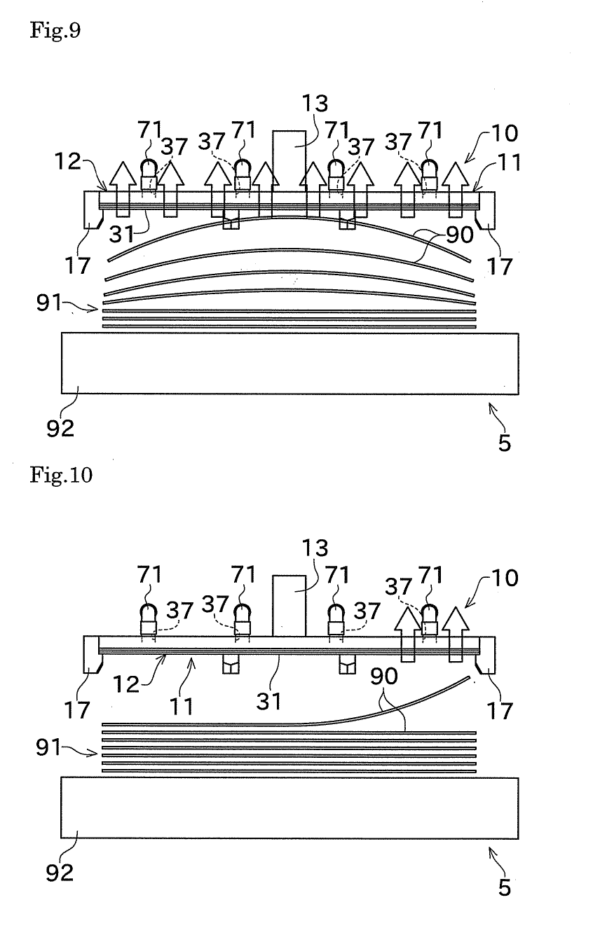

In the following, effects thereof will be described. FIG. 9 is a side view showing a case where the compressed air is simultaneously supplied to all the connection ports 37. As shown in FIG. 9, an attempt to pull up the workpiece 90 by sucking the entire surface of the workpiece 90 at one time is likely to cause a negative pressure to occur in a space between the stacked workpieces 90. As a result, the lower workpieces 90 are also raised accordingly, which may cause a resistance to sticking and a positional disorder of the workpiece 90.

In this respect, this embodiment is configured to supply the compressed air with a time lag by appropriately controlling the open/close of each electromagnetic valve connected to each connection port 37. Thereby, as shown in FIG. 10, the compressed air is firstly supplied to the connection port 37 located at one end side, and then the compressed air is supplied to the adjacent connection port 37. Making a time lag in sucking enables the workpiece 90 to be held in such a manner that it is curled upward. This can prevent the lower workpieces 90 from being accordingly raised, and thus a smooth transfer operation is achieved.

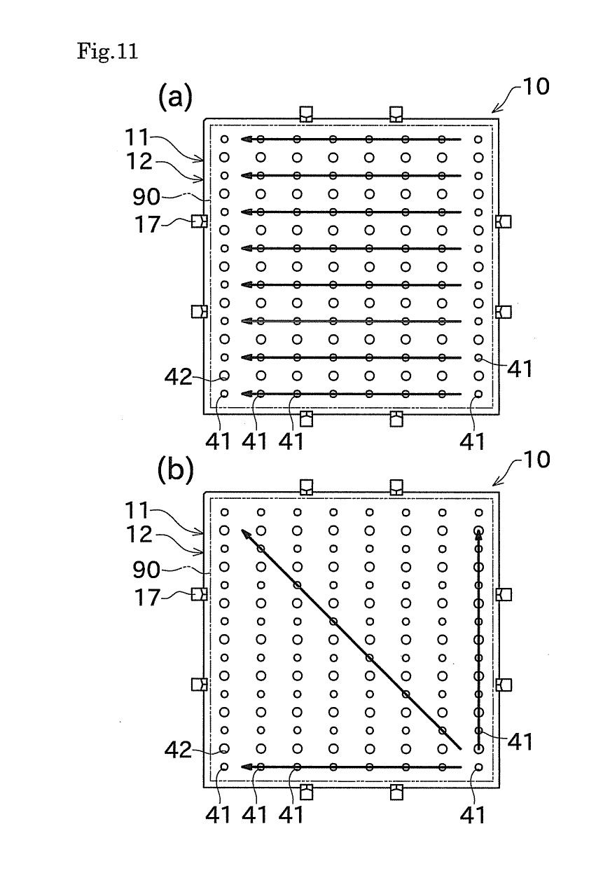

FIG. 11 is a bottom view showing the outline of an order in which the compressed air is supplied to the recesses 41 during a sucking operation for sucking the workpiece 90. FIG. 11(a) corresponds to this embodiment (FIG. 10), in which the compressed air is sequentially supplied in the order of the recess 41 located at one side, the recess 41 located at the center side, and the recess 41 located at the other side. Instead, it may be possible that the compressed air is sequentially supplied from one of the four corners toward the other corners of the opposing surface 31, as shown in FIG. 11(b). It may be also possible that the compressed air is simultaneously supplied to the recesses 41 located at both ends, not one end, of opposing surface 31, and then the compressed air is supplied to the recesses 41 located at the center side.

Next, a configuration for restricting movement of the workpiece 90 being held will be described. As shown in FIG. 3 and the like, a plurality of guide members 17 arranged at intervals are fixed to the edge of the main body 11 so as to surround the main body 11. Two guide members 17 are arranged on each side of the main body 11 having a rectangular. The guide members 17 are arranged such that they are opposed to each other across the main body 11. The guide member 17 is arranged so as to extend perpendicularly to the thickness direction of the main body 11 having a flat plate shape. The lower end of the guide member 17 protrudes downward beyond the lower surface (opposing surface 31) of the main body 11. When the workpiece 90 held by the suction chuck 10 is conveyed, the guide members 17 restrict relative movement of the workpiece 90 in a direction parallel to the lower surface (opposing surface 31) of the main body 11.

Next, the workpiece feeder 5 will be described with reference to FIG. 2 and the like. The workpiece feeder 5 mainly includes a support platform 81, an elevation stage 82, a linear actuator 83, and an air nozzle (sprayer) 84.

The elevation stage 82 configured such that a cassette 92 is placed thereon, is supported on an upper side of the support platform 81. The linear actuator 83 attached to the support platform 81 is coupled to the elevation stage 82. A plurality of linear guides 85 are attached to the elevation stage 82. Guiding by the linear guides 85 allows the elevation stage 82 to slidably move in the vertical direction. In this configuration, driving the linear actuator 83 causes the elevation stage 82 to move up and down.

The cassette 92 configured to accommodate a plurality of workpieces 90 in a stacked state is placed on the elevation stage 82. Here, the plurality of workpieces 90 are placed on the elevation stage 82 in a state where they are positioned by an appropriate positioning mechanism. In the following description, a plurality of workpieces 90 being stacked in the thickness direction may be particularly referred to as a batch of workpieces 91.

A nozzle support member 86 is attached to the side of the support platform 81 such that the nozzle support member 86 extends perpendicularly. The air nozzle 84 is attached to an upper end portion of the nozzle support member 86. The air nozzle 84 includes a cylindrical body 87 having a hollow cylindrical shape. The cylindrical body 87 has a plurality of spray holes 88 formed therethrough. The spray holes 88 are arranged in one line at equal intervals along the axial direction of the cylindrical body 87.

The cylindrical body 87 of the air nozzle 84 is arranged substantially at the same height as the cassette 92. The cylindrical body 87 is supported on the nozzle support member 86 such that the axis line of the cylindrical body 87 extends horizontally. A longitudinal end portion of the cylindrical body 87 is connected to a compressed air source (compressed gas source) via a pipe 89 and an electromagnetic valve (not shown). In this configuration, opening the electromagnetic valve and supplying compressed air into the cylindrical body 87 can cause air to be ejected from the spray holes 88 to thereby blast the air to the side surface of the batch of workpieces 91 placed in the cassette 92.

The cylindrical body 87 of the air nozzle 84 is supported on the nozzle support member 86 such that the cylindrical body 87 is rotatable about its axis line. Accordingly, by rotating the cylindrical body 87, the orientation of the spray holes 88 can be adjusted such that airflow acts on the side surface of the batch of workpieces 91 in a good manner.

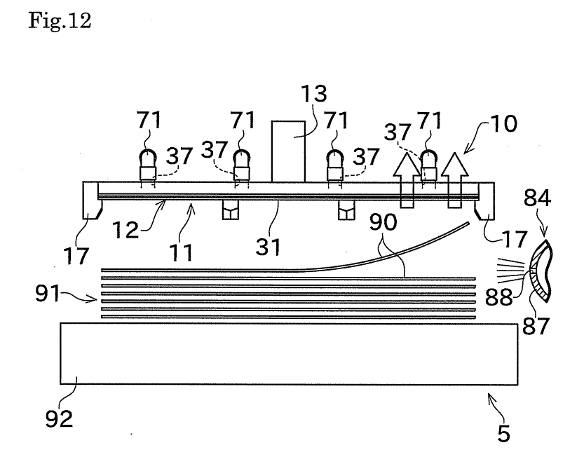

Air spraying through the spray holes 88 exerts an excellent effect particularly in combination with sucking with the time lag performed by the suction chuck 10. That is, as shown in FIG. 12, an airflow is applied from the spray holes 88 to an end portion of the batch of workpieces 91, and at and around this time, the compressed air is firstly supplied only to the recess 41 located at the side near the end portion to which the airflow is applied. Then, the compressed air is sequentially supplied to the recesses 41 such that a sucked region spreads toward the other end portion. As a result, the end portion of the workpiece 90 can be easily curled upward, and the workpiece 90 can be smoothly held by the suction chuck 10.

Next, experiments conducted with use of the suction chuck 10 of this embodiment will be described. In the experiments, the relationship between the flow rate of the supplied compressed air and the suction force was examined with respect to various suction chucks having different configurations.

In the experiments, three kinds of suction chucks were prepared, namely, the suction chuck 10 according to this embodiment shown in FIG. 7, a suction chuck having no escape hole 42 formed therein, and a suction chuck according to a reference example. The suction chuck according to the reference example was configured such that four large Bernoulli elements each having a cylindrical shape as disclosed in the Patent Document 1 were arranged in the form of 2×2 on a main body whose opposing surface has a square shape. The suction chuck according to the reference example has almost the same size as the size of the suction chuck according to this embodiment.

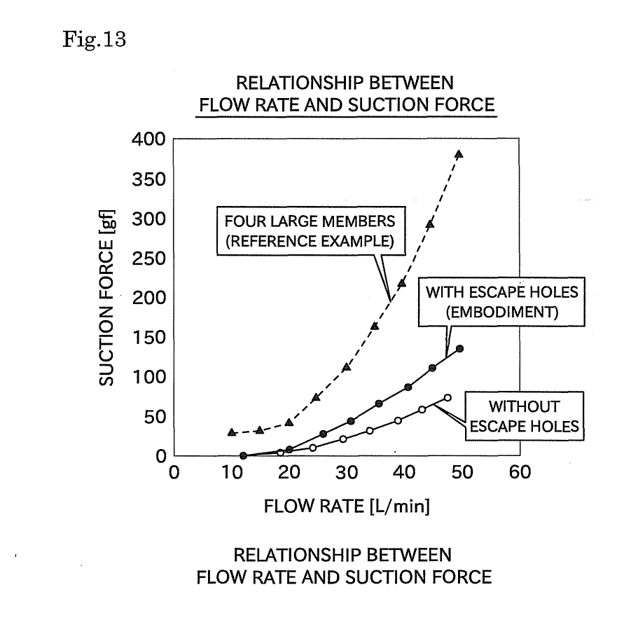

FIG. 13 shows a result of this experiment. As shown in this graph, it was confirmed that the suction chuck 10 according to this embodiment can exert a sufficiently strong suction force, though it is less than a suction force of the suction chuck according to the reference example. It was also revealed that the suction chuck 10 having the escape holes 42 exerts a stronger suction force than the suction chuck having no escape hole 42.

In the next experiment, the amount of deformation and the acceleration of vibration of a workpiece 90 were examined with respect to each of cases where the workpiece 90 was held by the suction chuck 10 (having the escape holes 42) according to this embodiment and by the suction chuck according to the reference example. More specifically, the suction chuck was arranged above an XY stage, and the workpiece 90 was actually held by the suction chuck. In this condition, the workpiece 90 was measured from the lower side thereof by means of a laser distance meter attached to the XY stage. This measurement was conducted at several positions with movement of the laser distance meter in the XY stage along a diagonal direction of the opposing surface of the suction chuck. The flow rate of the compressed air supplied to each suction chuck was adjusted such that the suction force of the suction chuck 10 according to this embodiment and the suction force of the suction chuck according to the reference example were almost equal.

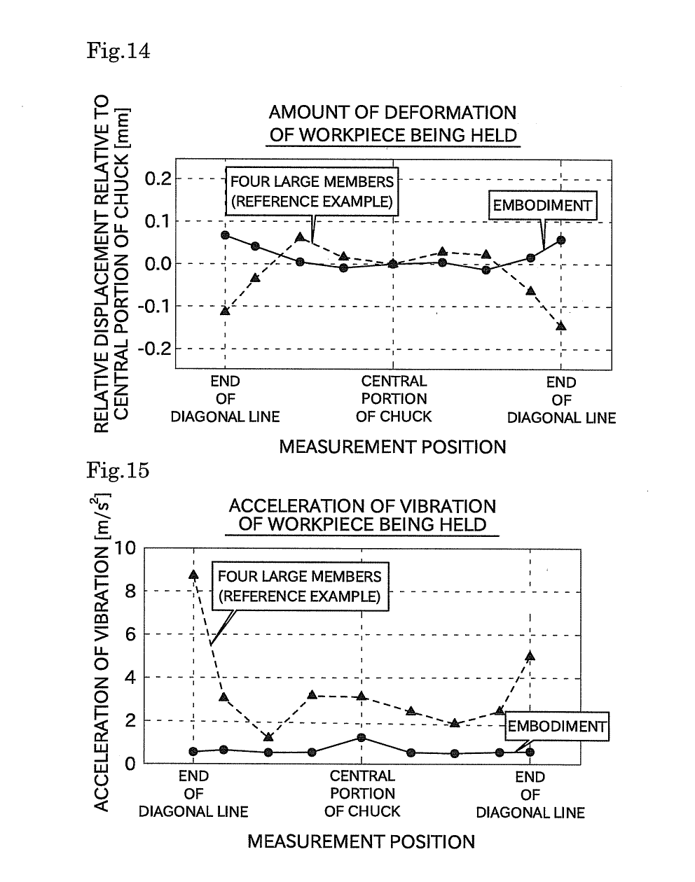

FIG. 14 shows a result of the measurement of the amount of deformation of the workpiece 90, in the form of a relative displacement relative to a central portion of the suction chuck (opposing surface). This reveals that, as compared with the suction chuck according to the reference example, the suction chuck 10 according to this embodiment could hold the workpiece 90 with more suppression of deformation of the workpiece 90.

However, the suction chuck 10 according to this embodiment shows a tendency that the workpiece 90 being held was deformed such that the central portion thereof slightly protruded downward, as shown in FIG. 14. To correct this, it is conceivable that compressed air having a slightly higher flow rate is supplied to the recesses 41 located in the central portion of the opposing surface 31 as compared with the recesses 41 located in the end portion of the opposing surface 31, so that the suction force increases at the center side. This can relieve the phenomenon that the central portion of the workpiece 90 protrudes downward, and enables the workpiece 90 to be held with a more horizontal and flat shape.

FIG. 15 shows a result of the measurement of the acceleration of vibration. This reveals that, as compared with the chuck according to the reference example, the suction chuck 10 according to this embodiment could suppress vibration (chatter) of the workpiece 90 very successfully. The suppression of the deformation and vibration of the workpiece 90 extremely reduces the possibility of occurrence of a contact between the workpiece 90 and the opposing surface 31, so that the non-contact ability is considerably improved.

As thus far described, in this embodiment, the suction chuck 10 for sucking the workpiece 90 of thin flat-plate shape and holding the workpiece 90 in a non-contact state includes the main body 11 having a flat plate shape and the opposing surface 31. The compressed air passage is formed in the main body 11. The opposing surface 31 is a surface of the main body 11 at the side facing the workpiece 90. The plurality of recesses 41, which serve as a sucking element for generating a negative pressure by ejecting the compressed air, are formed in the opposing surface 31. The opposing surface 31 is formed with a shape similar to the shape of the workpiece 90 (or with a shape corresponding to the shape of the workpiece 90 being offset outward) such that the shape of the opposing surface 31 is able to completely cover the shape of the workpiece 90 when seen along the direction perpendicular to the opposing surface 31. The recesses 41 are arranged such that all of the recesses 41 are coverable by the shape of the workpiece 90 when seen along the direction perpendicular to the opposing surface 31.

This can well prevent the workpiece 90 from being broken by a contact with the edge of the opposing surface 3, and also enables the sucking through the recesses 41 to act efficiently, so that the workpiece 90 is held stably.

In the suction chuck 10 according to this embodiment, the opposing surface 31 and the workpiece 90 have right-angled quadrangular shapes when seen along the direction perpendicular to the opposing surface 31.

Accordingly, the workpiece 90 having a right-angled quadrangular shape, which is a widely adopted shape, can be smoothly held without being broken.

In the suction chuck 10 according to this embodiment, the opposing surface 31 has the escape holes 42 formed therein. The escape holes 42 are opened around the recesses 41. The escape holes 42 are configured to discharge the compressed air ejected from the recesses 41. The escape holes 42 are arranged such that all of the escape holes 42 are coverable by the shape of the workpiece 90 when seen along the direction perpendicular to the opposing surface 31.

This allows the sucking through the recesses 41 to be efficiently exerted. Additionally, a lower flow rate can be used to achieve the same level of suction force. This is suitable for use in a clean room environment which requires suppression of the flow rate. Furthermore, break of the workpiece 90 caused by a contact thereof with an open edge of the escape hole 42 can be prevented well.

In the suction chuck 10 according to this embodiment, the plurality of recesses 41 are orderly arranged such that a line of the recesses 41 is in parallel with the side of the shape of the opposing surface 31 when seen along the direction perpendicular to the opposing surface 31.

This allows the sucking through the recesses 41 to act on the workpiece 90 without non-uniformity. Therefore, the workpiece 90 can be stably held.

In the suction chuck 10 according to this embodiment, the recess 41 has a cylindrical shape. The main body 11 includes a nozzle passage 44 configured to eject the compressed air in the direction along the inner wall of the recess 41.

Accordingly, with a simple configuration, a good swirling flow can be generated within the recess 41.

In the suction chuck 10 according to this embodiment, the nozzle passage 44 is formed so as to extend in parallel with the opposing surface 31.

Accordingly, the passage structure can be simplified and made compact.

In the suction chuck 10 according to this embodiment, two nozzle passages 44 are formed for one recess 41.

Accordingly, a stable swirling flow with a strong force can be generated in the recess 41.

In the suction chuck 10 according to this embodiment, the main body 11 is formed of the four plates 25 to 28 being bonded in their thickness direction. The four plates includes the surface plate 25 having the opposing surface 31 and the distribution plate 28 connected to the compressed air source that is a source for supplying the compressed air. The surface plate 25 has the circular holes 32 each constituting a part of the recess 41. The circular hole 32 is opened in the opposing surface 31. The nozzle passage 44 is arranged at a position between the opposing surface 31 and the distribution plate 28. The distribution plate 28 has the connection ports 37 and the distribution grooves 38. The connection ports 37, which are connected to the compressed air source, are arranged at the side opposite to the side close to the surface plate 25. The distribution grooves 38 are formed in the surface of the distribution plate 28 at the side close to the surface plate 25. The distribution groove 38 constitutes the distribution passage through which the compressed air introduced to the connection port 37 is led to the nozzle passage 44.

Accordingly, a passage structure with a simple configuration is achieved.

In the suction chuck 10 according to this embodiment, the nozzle plate 26 is arranged between the surface plate 25 and the distribution plate 28. The nozzle plate 26 has the slits 34 formed therethrough in the thickness direction. The slit 34 constitutes the nozzle passage 44.

Accordingly, the nozzle passage 44 can be formed with a simple configuration.

In the suction chuck 10 according to this embodiment, the connecting plate 27 is arranged between the surface plate 25 and the distribution plate 28. The connecting plate 27 has the connection holes 36 formed therein. The connection hole 36 connects the nozzle passage 44 and the distribution groove 38 to each other. A surface of the connecting plate 27 at one side with respect to the thickness direction constitutes a part of the inner wall of the nozzle passage 44. A surface of the connecting plate 27 at the other side with respect to the thickness direction closes the open side of the distribution groove 38, so that the distribution passage 43 is formed.

Accordingly, the compressed air passage can be formed with a simple configuration.

The suction chuck 10 according to this embodiment includes eight distribution passages 43 each connected to the plurality of nozzle passages 44.

Accordingly, the compressed air can be supplied from the distribution passage 43 to the plurality of nozzle passages 44. Therefore, the passage from the compressed air source to the connection port 37 can be simplified.

The suction chuck 10 according to this embodiment includes the plurality of distribution passages 43. A combination of the connection port 37 and the nozzle passages 44 connected by one distribution passage 43 is independent of a combination of the connection port 37 and the nozzle passages 44 connected by another distribution passage 43.

Accordingly, which recess 41 causes the sucking can be easily controlled by changing the connection port 37 to which the compressed air is supplied.

In the suction chuck 10 according to this embodiment, each of the plurality of plates 25 to 28 is made of a metal. The main body 11 is formed by laminating all the plurality of plates 25 to 28 and diffusion-bonding the plurality of plates 25 to 28 in the laminated state to one another.

Accordingly, the main body 11 in which the compressed air passage is provided can be formed through a simple process.

In the suction chuck 10 according to this embodiment, the plurality of plates 25 to 28 are made of a material selected from the group consisting of stainless steel, an aluminum alloy, and a titanium alloy.

Accordingly, the low-cost suction chuck 10 can be provided.

In the suction chuck 10 according to this embodiment, all of the plurality of plates 25 to 28 are made of the same metal material.

Accordingly, a suction chuck causing less distortion and achieving a good accuracy of dimension can be provided.

In the suction chuck 10 according to this embodiment, the recesses 41 and the nozzle passages 44 are formed through an etching process.

Accordingly, the passage structure can be made easily.

In the suction chuck 10 according to this embodiment, it may be also acceptable that the recesses 41 and the nozzle passages 44 are formed through a machining process.

This increases the degree of freedom in a processed shape, and accordingly even a complicated passage structure can be made easily.

In the suction chuck 10 according to this embodiment, the connection ports 37 and the distribution grooves 38 are formed through a machining process.

This increases the degree of freedom in a processed shape, and accordingly even a complicated passage structure can be made easily.

The transfer robot 1 disclosed in this embodiment includes the suction chuck 10 and the compressed air source. The compressed air source is a compressed-air supply source for supplying the compressed air to the suction chuck 10. The amount of compressed air ejected from the recesses 41 that are located in the central portion of the opposing surface 31 is larger than the amount of compressed air ejected from the recesses 41 that are located in the end portion of the opposing surface 31.

Accordingly, the workpiece 90 can be held while maintaining a more flat shape.

The transfer robot 1 according to this embodiment is configured to separate uppermost one workpiece 91 away from the batch of workpieces 91 that is a stack of a plurality of workpieces 90 and to hold the uppermost one workpiece 91 by the suction chuck 10. The transfer robot 1 according to this embodiment is configured to hold the workpiece 90 positioned in the uppermost layer of the batch of workpieces 91, by supplying the compressed air to, among the plurality of recesses 41 arranged in the suction chuck 10, the recesses 41 located in the end portion of the opposing surface 31, and then supplying the compressed air to the recesses 41 located in the central portion of the opposing surface 31.

Accordingly, sucking of and holding the workpiece 90 can be performed in such a manner that the workpiece 90 is curled upward from the end portion thereof. Therefore, a smooth transfer operation is achieved.

The transfer robot 1 according to this embodiment includes the air nozzle 84 configured to blast compressed air toward the side surface of the batch of workpieces 91.

This makes it easy to separate the workpiece 90 away from the batch of workpieces 91. Therefore, a smooth transfer operation is achieved.

The transfer robot 1 according to this embodiment includes the parallel mechanism 2 configured to move the workpiece 90 being held by the suction chuck 10.

Accordingly, the effects exerted by the configuration of the suction chuck 10 described above can be applied to a transfer robot of parallel mechanism type.

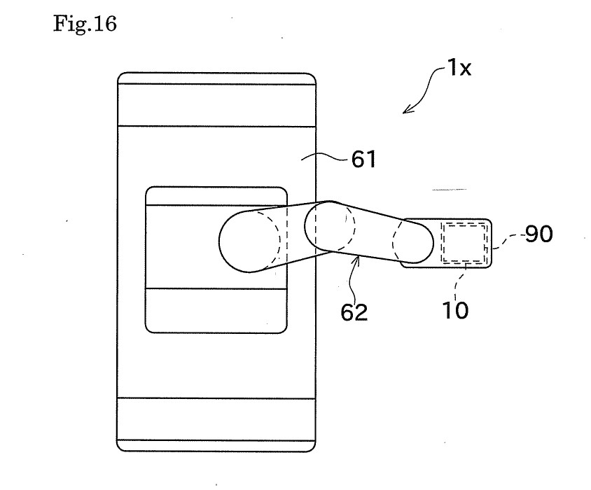

The suction chuck 10 can be mounted to the parallel mechanism 2 as described above, but instead, application to a transfer robot 1x of scara arm type as shown in FIG. 16 is also acceptable. FIG. 16 is a plan view showing a modification example in which the suction chuck 10 is attached to a transfer robot 1x having a scara arm 62.

The transfer robot 1x mainly includes a robot main body 61 and a scara arm 62. A base of the scara arm 62, which is bendable, is attached to the robot main body 61. Driving a motor (not shown) can cause a distal end portion of the scara arm 62 to move horizontally and vertically to any position while keep the scara arm 62 horizontal.

The suction chuck 10 is mounted to a lower surface of the distal end portion of the scara arm 62, so that the workpiece 90 can be held in a non-contact state. When the scara arm 62 is driven under a state where the workpiece 90 is held by the suction chuck 10, the workpiece 90 can be moved to an appropriate position.

In the transfer robot 1x, a main body of the suction chuck 10 can be thin. Accordingly, for example, even in a cassette that accommodates a plurality of workpieces 90 in a stacked manner at spaces therebetween with respect to the vertical direction, a random access is enabled in which, for example, the distal end of the scara arm 62 having the suction chuck 10 mounted thereto is inserted into the cassette to extract a workpiece 90 arranged in any position and then the workpiece 90 is stored.

As illustrated above, the transfer robot 1x shown in FIG. 16 includes the scara arm 62 configured to move the workpiece 90 being held by the suction chuck 10.

Accordingly, the effects exerted by the configuration of the suction chuck 10 described above can be applied to the transfer robot of scara arm type.

While a preferred embodiment of the present invention and a modification thereof have been described above, the above-described configurations can be changed, for example, as follows.

Although each of the workpiece 90 and the opposing surface 31 has a square shape in the above-described embodiment, the shape may be a right-angled quadrangle in which adjacent sides have different lengths.

The numbers of the recesses 41 and the escape holes 42 formed in the opposing surface 31, and a manner in which they are arranged, can be appropriate changed in accordance with the weight, size, or the like, of the workpiece 90.

Although the above-described embodiment is configured such that the two nozzle passages 44 (slits 34) are connected to the recess 41, the number of the connected nozzle passages may be one, or may be three or more.

### DESCRIPTION OF THE REFERENCE NUMERALS

1,1x transfer robot (transfer apparatus)

10 suction chuck

11 main body

25 surface plate (first plate)

26 nozzle plate (intermediate plate)

27 connecting plate (third plate)

28 distribution plate (second plate)

31 opposing surface

32 circular hole (open hole)

36 connection hole

37 connection port

38 distribution groove (supply groove)

41 recess

42 escape hole

43 distribution passage (supply passage)

44 nozzle passage (ejection passage)

84 air nozzle (sprayer)

90 workpiece

91 batch of workpieces

1. A suction chuck for sucking a workpiece of thin flat-plate shape and holding the workpiece in a non-contact state, the suction chuck comprising:
a main body having a flat plate shape, in which a passage for a compressed gas is formed; and
an opposing surface that is a surface of the main body at the a side facing the workpiece, the opposing surface having a plurality of recesses formed therein, the plurality of recesses serving as a sucking element for generating a negative pressure by ejecting the compressed gas, wherein,
the opposing surface being formed with a shape similar to the a shape of the workpiece or with a shape that corresponds to the shape of the workpiece being offset outward, such that the shape of the opposing surface is able to completely cover the shape of the workpiece when seen along a direction perpendicular to the opposing surface,
the recesses being arranged such that all of the recesses are coverable by the shape of the workpiece when seen along the direction perpendicular to the opposing surface.

2. The suction chuck according to claim 1, wherein
the opposing surface and the workpiece have right-angled quadrangular shapes when seen along the direction perpendicular to the opposing surface.

3. The suction chuck according to claim 1, wherein
the opposing surface has escape holes formed therein, the escape holes being opened around the recesses and being configured to discharge the compressed gas ejected from the recesses, and
the escape holes are arranged such that all of the escape holes are coverable by the shape of the workpiece when seen along the direction perpendicular to the opposing surface.

4. The suction chuck according to claim 1, wherein
the plurality of recesses are orderly arranged such that a line of the recesses is in parallel with a side of the shape of the opposing surface when seen along the direction perpendicular to the opposing surface.

5. The suction chuck according to claim 1, wherein
the recess has a cylindrical shape,
the main body includes an ejection passage configured to eject the compressed gas in a direction along an inner wall of the recess.

6. The suction chuck according to claim 5, wherein
the ejection passage is formed so as to extend in parallel with the opposing surface.

7. The suction chuck according to claim 5, wherein
a plurality of the ejection passages are formed for one recess.

8. The suction chuck according to claim 5, wherein
the main body is formed of a plurality of plates being bonded in a thickness direction, the plurality of plates including a first plate and a second plate, the first plate having the opposing surface, the second plate being connected to a compressed gas source that is a source for supplying the compressed gas,
the first plate has an open hole, the open hole being opened in the opposing surface, the open hole constituting at least a part of the recess,
the ejection passage is arranged at a position between the opposing surface and the second plate, and
the second plate has a connection port and a supply groove, the connection port being connected to the compressed gas source and being arranged at the side opposite to the side close to the first plate, the supply groove being formed in a surface of the second plate at the side close to the first plate, the supply groove constituting a supply passage through which the compressed gas introduced to the connection port is led to the ejection passage.

9. The suction chuck according to claim 8, wherein
an intermediate plate is arranged between the first plate and the second plate, and
the intermediate plate has a slit formed therethrough in a thickness direction, the slit constituting the ejection passage.

10. The suction chuck according to claim 8, wherein
a third plate is arranged between the first plate and the second plate,
the third plate has a connection hole formed therein, the connection hole connecting the ejection passage and the supply groove to each other,
a surface of the third plate at one side with respect to a thickness direction constitutes a part of the inner wall of the ejection passage, and
a surface of the third plate at the other side with respect to the thickness direction closes an open side of the supply groove, so that the supply passage is formed.

11. The suction chuck according to claim 8, wherein
including at least one said supply passage, each of said supply passages being connected to a plurality of the ejection passages.

12. The suction chuck according to claim 8, including a plurality of the supply passages, wherein
a combination of the connection port and the ejection passages connected by one of the supply passages is independent of a combination of the connection port and the ejection passages connected by another of the supply passages.

13. The suction chuck according to claim 8, wherein
each of the plurality of plates is made of a metal, and the main body is formed by laminating all the plurality of plates and diffusion-bonding the plurality of plates in a laminated state to one another.

14. The suction chuck according to claim 13, wherein
the plurality of plates are made of a material selected from the group consisting of stainless steel, an aluminum alloy, and a titanium alloy.

15. The suction chuck according to claim 13, wherein
all of the plurality of plates are made of the same metal material.

16. The suction chuck according to claim 13, wherein
at least either of the recess and the ejection passage is formed through an etching process.

17. The suction chuck according to claim 13, wherein
at least either of the recess and the ejection passage is formed through a machining process.

18. The suction chuck according to claim 13, wherein
at least either of the connection port and the supply groove is formed through a machining process.

19. A workpiece transfer apparatus comprising:
the suction chuck according to claim 1; and
a compressed gas source that is a source for supplying the compressed gas to the suction chuck, wherein
the amount of the compressed gas ejected from the recess that is located in a central portion of the opposing surface is larger than the amount of the compressed gas ejected from the recess that is located in an end portion of the opposing surface.

20. A workpiece transfer apparatus comprising:
the suction chuck according to claim 1; and
a compressed gas source that is a source for supplying the compressed gas to the suction chuck,
the workpiece transfer apparatus being configured to separate an uppermost one workpiece away from a batch of workpieces that is a stack of a plurality of the workpieces, and to hold the uppermost one workpiece by the suction chuck,
the workpiece transfer apparatus being configured to hold the workpiece positioned in an uppermost layer of the batch of workpieces, by supplying the compressed gas to, among the plurality of recesses arranged in the suction chuck, the recesses located in an end portion of the opposing surface and then supplying the compressed gas to the recesses located in a central portion of the opposing surface.

21. The workpiece transfer apparatus according to claim 20, comprising a sprayer configured to blast compressed gas toward a side surface of the batch of workpieces.

22. The workpiece transfer apparatus according to any one of claims 19 to 21, comprising a parallel mechanism configured to move a workpiece being held by the suction chuck.

23. The workpiece transfer apparatus according to any one of claims 19 to 21, comprising a scara arm configured to move a workpiece being held by the suction chuck.
